(19) United States
(12) Patent Application Publication
(10) Pub. No.: US 2025/0208895 A1
(43) Pub. Date: Jun. 26, 2025

(54) MULTI-CLUSTER SERVICE SYSTEM, SERVICE ACCESS METHOD, INFORMATION CONFIGURATION METHOD, DEVICE, AND MEDIUM

(71) Applicant: Cloud Intelligence Assets Holding (Singapore) Private Limited, Singapore (SG)

(72) Inventors: Xiaomin WU, Hangzhou (CN); Yang SONG, Hangzhou (CN); Zhigang ZONG, Hangzhou (CN)

(73) Assignee: Cloud Intelligence Assets Holding (Singapore) Private Limited, Singapore (SG)

(21) Appl. No.: 18/851,568

(22) PCT Filed: Mar. 29, 2023
(86) PCT No.: PCT/CN2023/084749

§ 371 Date: Sep. 26, 2024

(30) Foreign Application Priority Data
Mar. 31, 2022 (CN) 202210346226.1

(51) Int. Cl. G06F 9/455

(52) U.S. Cl. CPC G06F 9/45558; G06F 2009/4557; G06F 2009/45595

(57) ABSTRACT

A multi-cluster service system, a service access method, an information configuration method, a device, and a medium. VPCs bearing service clusters are divided into a service VPC and a client VPC, a target service having different service information in the service VPC and the client VPC; the service information specifically can be provided by virtual network interface controller devices in the service VPC and the client VPC, and, by maintaining the different service information of the target service in the client VPC and the service VPC and by being capable of providing a mapping relation between service instance information of the target service, a cross-VPC service is realized.

### CROSS REFERENCE TO RELATED APPLICATIONS

The present application claims priority to Chinese Patent Application No. 202210346226.1, filed with the China Patent Office on Mar. 31, 2022 and titled “MULTI-CLUSTER SERVICE SYSTEM, SERVICE ACCESS METHOD, INFORMATION CONFIGURATION METHOD, DEVICE, AND MEDIUM”, which is incorporated herein by reference in its entirety.

### TECHNICAL FIELD

The present application relates to the field of cloud computing technology, and, in particular, to a multi-cluster service system, a service access method and an information configuration method, a device, and a medium.

### BACKGROUND

With the development of cloud computing technology, a container orchestration system based on kubernetes (K8s) has become the de facto standard in the industry, and K8s multi-cluster deployment has become a mainstream model. The deployment of multiple K8s clusters can be based on factors such as application layering and deployment location, and there are a large number of access demands for services between the multiple K8s clusters.

### SUMMARY

Various aspects of the present application provide a multi-cluster service system, a service access method and an information configuration method, a device, and a medium.

An embodiment of the present application provides a multi-cluster service system, including: a plurality of service clusters for providing services externally and distributed in a plurality of VPCs; wherein the plurality of VPCs include at least one service VPC responsible for providing a target service and at least one client VPC which can access the target service, and the target service having first service information in each service VPC and second service information in each client VPC; the system further including: a multi-cluster load balancing node for generating in advance an information mapping relationship among second service information which the target service has in each client VPC, first service information which the target service has in each service VPC, and information of a service instance in each service VPC which can provide the target service; and load-balancing, based on the information mapping relationship, an access request for the target service from any client VPC onto a target service instance in the at least one service VPC, to enable the target service instance to provide the target service for a service instance corresponding to the access request.

An embodiment of the present application further provides a service access method, applicable to a multi-cluster load balancing node in a multi-cluster service system including at least one service VPC responsible for providing a target service and at least one client VPC which can access the target service, this method including: generating in advance an information mapping relationship among second service information which the target service has in each client VPC, first service information which the target service has in each service VPC, and information of a service instance in each service VPC which can provide the target service; and load-balancing, based on the information mapping relationship, an access request for the target service from any client VPC onto a target service instance in the at least one service VPC, to enable the target service instance to provide the target service for a service instance corresponding to the access request.

An embodiment of the present application provides an information configuration method, applicable to a multi-cluster service management and control node in a multi-cluster service system including at least one service VPC responsible for providing a target service and at least one client VPC which can access the target service, this method including: acquiring and delivering second service information which the target service has in each client VPC, first service information which the target service has in each service VPC, and information of a service instance in each service VPC which can provide the target service to a multi-cluster load balancing node, to be used by the multi-cluster load balancing node to locally generate an information mapping relationship; wherein the information mapping relationship is used for load balancing an access request for the target service from any client VPC onto a target service instance in the at least one service VPC.

An embodiment of the present application provides a load balancing apparatus in a multi-cluster service system, and this apparatus can be implemented as a multi-cluster load balancing node in a multi-cluster service system including at least one service VPC responsible for providing a target service and at least one client VPC which can access the target service, this apparatus including: a generation module for generating in advance an information mapping relationship among second service information which a target service has in each client VPC, first service information which the target service has in each service VPC, and information of a service instance in each service VPC which can provide the target service; and a load balancing module for load-balancing, based on the information mapping relationship, an access request for the target service from any client VPC onto a target service instance in the at least one service VPC, to enable the target service instance to provide the target service for a service instance corresponding to the access request.

An embodiment of the present application further provides a management and control apparatus for use in a multi-cluster service system including at least one service VPC responsible for providing a target service and at least one client VPC which can access the target service, this apparatus including: an acquisition module and a sending module for acquiring and delivering second service information which the target service has in each client VPC, first service information which the target service has in each service VPC, and information of a service instance in each service VPC which can provide the target service to a multi-cluster load balancing node, to be used by a multi-cluster load balancing node to locally generate an information mapping relationship; wherein the information mapping relationship is used for load balancing an access request for the target service from any client VPC onto a target service instance in the at least one service VPC.

An embodiment of the present application further provides a node device for use in a multi-cluster service system, including: a memory for storing a computer program; and a processor coupled to the memory for executing the computer program to cause the processor to implement respective steps in the service access method and the information configuration method provided in the embodiments of the present application.

An embodiment of the present application further provides a computer-readable storage medium stored with a computer program, wherein the computer program, when executed by a processor, causes the processor to implement steps in the service access method provided in the embodiment of the present application.

### BRIEF DESCRIPTION OF THE DRAWINGS

The drawings explained here are used to provide further understanding of the present application, and constitute a part of the present application. Schematic embodiments of the present application and explanations thereof are used to expound the present application, and do not constitute improper limitations to the present application. In the drawing:

FIG. 1a is a schematic structural diagram of a multi-cluster service system provided in an exemplary embodiment of the present application;

FIG. 1b is a schematic structural diagram of another multi-cluster service system provided in an exemplary embodiment of the present application;

FIG. 1c is a schematic diagram of a multi-cluster service system that integrates containers and VMs provided in an exemplary embodiment of the present application;

FIG. 2a is a schematic structural diagram of a control plane of a multi-cluster service system provided in an exemplary embodiment of the present application;

FIG. 2b is a schematic structural diagram of a control plane and a data plane of a multi-cluster service system provided in an exemplary embodiment of the present application;

FIG. 3a is a schematic flow chart of a service access method provided in an exemplary embodiment of the present application;

FIG. 3b is a schematic flow chart of an information configuration method provided in an exemplary embodiment of the present application;

FIG. 4a is a schematic structural diagram of a load balancing apparatus provided in an exemplary embodiment of the present application;

FIG. 4b is a schematic structural diagram of a management and control apparatus provided in an exemplary embodiment of the present application; and

FIG. 5 is a schematic structural diagram of a node device for use in a multi-cluster service system provided in an exemplary embodiment of the present application.

### DETAILED DESCRIPTION

In order to make the purposes, technical solutions and advantages of the present application clearer, the technical solutions of the present application will be clearly and completely described below with reference to specific embodiments of the present application and corresponding drawings. Obviously, the described embodiments are only part of the embodiments of the present application, rather than all of the embodiments. Based on the embodiments in the present application, all other embodiments obtained by those of ordinary skill in the art without making creative labor should fall within the scope of protection of the present application.

In existing technologies, discovery and synchronous deployment of service information between different clusters are implemented by extending a CRD (Custom Resource Definition). However, such an approach is mainly applicable to multi-cluster services located in a same virtual private cloud (VPC). If two clusters are distributed in different VPCs, addresses of the VPCs are required not to overlap. Otherwise, access between multi-cluster services across the VPCs cannot be implemented through a private network.

In view of the technical problem that an existing multi-cluster service access cannot be implemented through a private network due to overlapping VPC addresses when the multi-cluster service access spans across VPCs, various aspects of the present application provide a multi-cluster service system, a service access method and an information configuration method, a device, and a medium.

In the embodiments of the present application, VPCs hosting service clusters are divided into a service VPC providing a target service externally and a client VPC for accessing the target service, the target service having different service information in the service VPC and the client VPC, and an information mapping relationship between the different service information which the target service has in the client VPC and the service VPC and information of a service instance in the service VPC which can provide the target service is maintained on a multi-cluster load balancing node, implementing the target service across the VPCs, so that a service instance in the client VPC can access the target service in the service VPC without limiting addresses of the VPCs, and address overlap is allowed between different VPCs in a case of performing multi-cluster service access across the VPCs, thereby implementing access between multi-cluster services across the VPCs.

The technical solutions provided in the embodiments of the present application are explained in detail below with reference to the drawings.

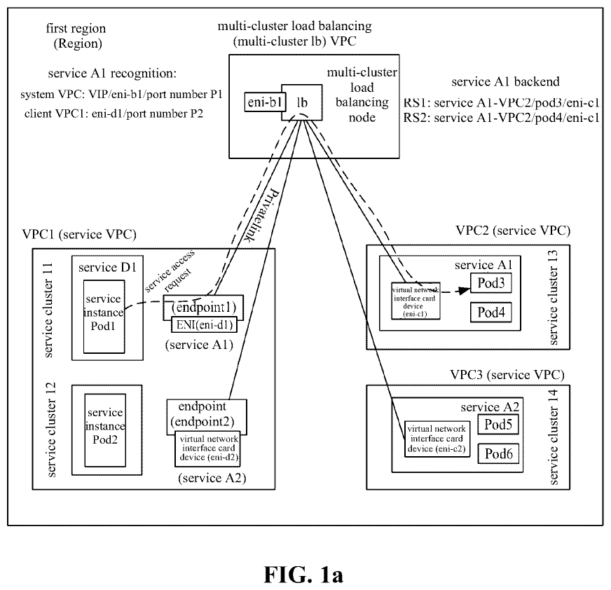

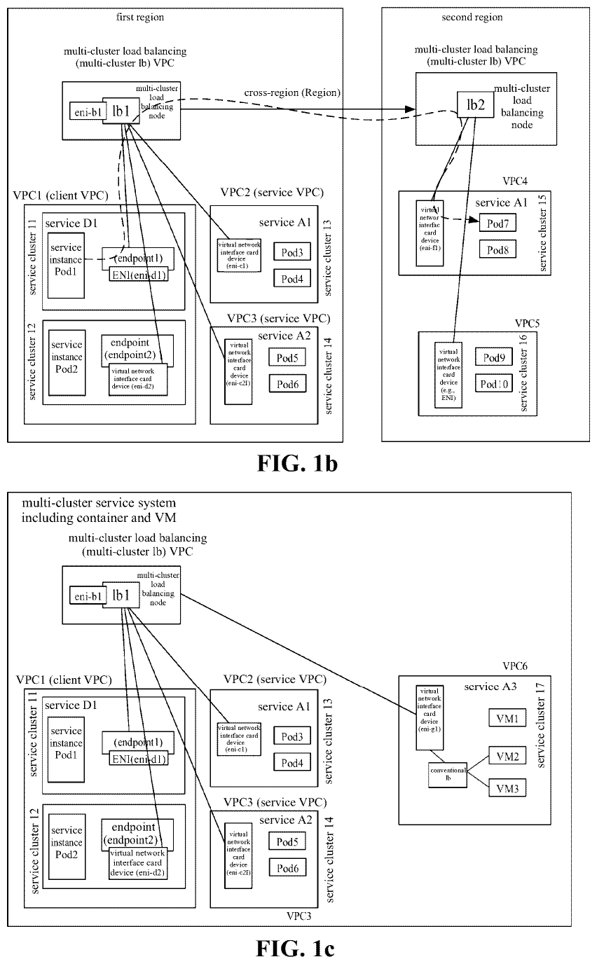

FIG. 1a is a schematic structural diagram of a multi-cluster service system provided in an exemplary embodiment of the present application. As shown in FIG. 1a, this multi-cluster service system includes: a plurality of service clusters for providing services externally and distributed in a plurality of VPCs. In FIG. 1a, service cluster 11 and service cluster 12 distributed in VPC1, service cluster 13 distributed in VPC2, and service cluster 14 distributed in VPC3 are taken as an example for illustration, to which no limitation is made in the present application.

Additionally, in FIG. 1a, there is illustrated a plurality of VPCs (i.e., VPC1, VPC2, and VPC3) located in a same region, to which no limitation is made in the present application. The multi-cluster service system in this embodiment supports span across different regions, that is, a plurality of service clusters in the multi-cluster service system can be deployed in the plurality of VPCs in different regions. FIG. 1b gives an example of a cross-region multi-cluster service system. In FIG. 1b, it includes a first region (Region1) and a second region (Region2), the first region including service clusters 11-14, of which service cluster 11 and service cluster 12 are distributed in VPC1, service cluster 13 is distributed in VPC2, and service cluster 14 is distributed in VPC3; and the second region including service cluster 15 deployed in VPC4 and service cluster 16 deployed in VPC5.

In this embodiment, a VPC is a logically isolated network environment constructed on a physical network by employing virtualization technology. The physical network includes various physical resources, such as a physical machine, a switch, or a gateway. One or more VPCs can be deployed on physical resources in one region, and a same VPC is usually deployed in one region. As shown in FIG. 1b, two regions are exhibited, with three VPCs deployed in the first region, namely, VPC1, VPC2, and VPC3, and two VPCs deployed in the second region, namely, VPC4 and VPC5. Each VPC includes at least one computing node that can be an elastic computing service (ECS) instance, a bare metal server, a virtual machine, or the like. The computing node is not illustrated in the systems shown in FIG. 1a and FIG. 1b. Deploying a VPC in one region specifically refers to deploying a computing node in the VPC on a physical machine in this region.

In this embodiment, the plurality of service clusters in the multi-cluster service system can be distributed in a same VPC, or can be distributed in a plurality of VPCs. In a case where the plurality of service clusters is distributed in the plurality of VPCs, a scenario of performing access between multi-cluster services across the VPCs may be involved. A same one service cluster is usually distributed in one VPC, but one or more service clusters can be deployed in a same VPC. In FIG. 1a and FIG. 1b, VPC1 in the first region including service cluster 11 and service cluster 12, VPC2 including service cluster 13, and VPC3 including service cluster 14 are taken as an example for illustration, to which no limitation is made in the present application.

In this embodiment, each service cluster can provide at least one service externally, each service is provided by one or more service instances in a service cluster where it is located, the service instance is an actual executor and provider of the service, each service instance provides one service, and different service instances can provide an identical service, or can provide different services. From a cluster perspective, services provided by different service clusters can be completely different, or can be completely identical, or some services can be identical while some services can be different.

From a service perspective, a same service can be deployed across regions, across VPCs, or across clusters. Deploying the service across the regions refers to deploying a plurality of service instances that provide a same service in different service clusters in different regions, and these different service clusters are usually distributed in two or more VPCs because they span across the regions. Deploying the service across the VPCs refers to deploying a plurality of service instances that provide a same service in different VPCs, and further refers to deploying them in different service clusters in different VPCs, and these different VPCs can span cross the regions, or can belong to a same region. Deploying the service across the clusters refers to deploying a plurality of service instances that provide a same service in different service clusters, and these different service clusters can belong to a same VPC, or can belong to different VPCs, and can be located in a same region, or can be located in different regions.

Service instances in each service cluster are deployed on a computing node in a VPC where this service cluster is located, and the computing node provides, for these service instances, various resources, such as a computing resource, a storage resource, a network resource, or the like, on which running of the service instances depends. In the embodiments of the present application, a form of implementation of a service instance is not limited, which, for example, can be a container, or can be a virtual machine, or can be a load balancer (lb). The load balancer mainly provides a load balancing service. In an optional embodiment, for a same service cluster, service instances contained therein are containers, and then this service cluster can be implemented as a container-based K8s cluster, which provides a containerized service externally, where the containerized service refers to a service implemented based on a container. In another optional embodiment, for a same service cluster, service instances contained therein are virtual machines, and this service cluster can be implemented as a virtual machine-based service cluster, which provides a virtual machine-based service externally, where the virtual machine-based service refers to a service implemented based on a virtual machine. The virtual machine-based service can be referred to as a traditional cloud service. In a further optional embodiment, for a same service cluster, a containerized service instance and a virtual machine-based service instance can exist at the same time, which not only can provide a containerized service externally, but also can provide a virtual machine-based service externally. From a VPC perspective, one or more service clusters are deployed in one VPC, and these service clusters can provide a containerized service alone, or can provide a virtual machine-based service alone, or, certainly, can provide two types of services externally at the same time. From a perspective of the multi-cluster service system, the entire system can provide a containerized service alone, or can provide a virtual machine-based service alone, or, certainly, can provide two types of services at the same time. As shown in FIG. 1c, it is a schematic diagram of a multi-cluster service system that integrates containers and VMs provided in an exemplary embodiment of the present application. Compared with FIG. 1a, there is one more service cluster 17 in FIG. 1c, service cluster 17 being hosted in VPC6, and a service in service cluster 17 being provided by VM. Although VM1-VM3 are shown in FIG. 1c, the present application is not limited to this. Further, VM2 and VM3 in FIG. 1c can perform load balancing via a conventional load balancing node (i.e., a conventional lb), and a load balancing service provided by this conventional lb can also be exposed externally as one service. FIG. 1a can be referred to for description of other parts in FIG. 1c, which will not be repeated here.

In this embodiment, different services can access each other. For any two services that can access each other, from a service cluster perspective, these two services can come from a same service cluster, or can come from different service clusters; from a VPC perspective, these two services can come from a same VPC, or can come from different VPCs; and from a region perspective, these two services can come from a same region, or can come from different regions.

In this embodiment, for each service, a VPC where this service is located is also a VPC where a service cluster to which this service belongs is located, that is, a VPC where a service instance in this service cluster which provides this service is located. In this embodiment, each VPC has its own available IP address network segment. A service cluster in this VPC can allocate a network sub-segment from the IP address network segment of this VPC, then allocate an IP address from this network sub-segment to a service provided by this service cluster, and further allocate an IP address to a service instance that specifically provides this service. In short, the IP addresses of the service and the service instance in this VPC can come from the IP address network segment of this VPC, and IP addresses of different services and service instances will not overlap. However, it should be noted that IP addresses of services or service instances in a VPC may also not come from an IP address network segment of this VPC, as long as they do not overlap with an IP address of this VPC. For different VPCs, since different VPCs are logically isolated from each other, IP address network segments of different VPCs can overlap. Likewise, services or service instances in different VPCs may use an identical IP address. When access is performed between two services across VPCs, if IP addresses of two services in different VPCs are identical, then these two services cannot perform service access due to an IP address conflict.

In an embodiment of the present application, VPCs are divided from a service perspective. The VPCs are divided into a service VPC and a client VPC. The service VPC refers to a VPC in which a service cluster contained therein can provide a service externally, and the client VPC refers to a VPC in which a service cluster contained therein has an access demand for the service. For ease of description and distinction, in an embodiment of the present application, taking a target service as an example, the target service can be any one service in the multi-cluster service system which can be exposed externally, and then the multi-cluster service system includes at least one service VPC which can provide this target service and at least one client VPC which can access this target service. Each service VPC can include one or more service clusters that can provide this target service. In a case where there is a plurality of service VPCs, the plurality of service VPCs can be located in a same region, or can be located in different regions. Each client VPC can include one or more service clusters that need to access this target service. The client VPC and the service VPC can be located in a same region, or can be located in different regions. A service instance in a service cluster which provides the target service can be deployed in a service VPC where it is located, or can be deployed in another environment associated with this service VPC, for example, another VPC, an edge cloud environment, or an offline IDC. Optionally, the edge cloud environment or the offline IDC is interconnected to the service VPC where this service instance is located through a leased line or VPN.

In this embodiment, the target service has first service information in each service VPC. The first service information indicates or represents the target service, and the first service information can include a private network IP address of the target service and a port number of the target service. For ease of description and distinction, a private network IP address of the target service in the service VPC is referred to as a first private network IP address. Optionally, the first private network IP address is an IP address in the service VPC. In an optional embodiment, one private network IP address can be directly applied for from the IP address of the service VPC for the target service, and a port number can be allocated to the target service, and the target service is indicated by this private network IP address and the port number. In another optional embodiment, a first virtual network interface card device can be deployed in the service VPC as a traffic access point of the target service, and this first virtual network interface card device has the first private network IP address, and the target service can be indicated by the first private network IP address of the first virtual network interface card device and the port number of the target service. It should be noted that first private network IP addresses that the target service has in different service VPCs may be identical, or may not be identical, which is not limited.

In order to implement access between multi-cluster services across VPCs, in this embodiment, for a target service, an endpoint corresponding to the target service is deployed in each client VPC. Second service information that the target service has in this client VPC is provided by this endpoint, and the second service information indicates or represents the target service. That is to say, a service instance in each service cluster contained in this client VPC can initiate access to the target service by the second service information. The second service information can include a private network IP address of the target service and a port number or a mapped port number of the target service. For ease of description and distinction, a private network IP address of the target service in the client VPC is referred to as a second private network IP address. Optionally, the second private network IP address is an IP address in the client VPC. In an optional embodiment, a second virtual network interface card device bound to the target service can be deployed in each client VPC as a traffic routing point of the target service, so as to route traffic of accessing the target service in the client VPC onto a multi-cluster load balancing node. The endpoint corresponding to the target service can be hosted on the second virtual network interface card device, and the second virtual network interface card device has a second private network IP address, and the target service can be indicated in the client VPC by the second private network IP address that the second virtual network interface card device has and the port number or the mapped port number of the target service. That is to say, the second service information that the target service has in this client VPC includes the second private network IP address and the port number or the mapped port number of the target service.

The mapped port number refers to another port number that has a mapping relationship with the port number of the target service. For example, assuming that the port number of the target service is 80, the port number of this target service may be mapped to 8080, 9090, 7070, or the like in the client VPC. It should be noted that second private network IP addresses of the target service in different client VPCs may be identical, or may not be identical; likewise, mapped port numbers of the target service in different client VPCs may be identical, or may not be identical. In a case where the target service has an identical second private network IP address and mapped port number in different client VPCs, access requests from different client VPCs can be distinguished by identification information of the client VPCs. Identification information of a client VPC can be an ID of the client VPC, a VNI in a VXLAN field, or can be various information capable of uniquely identifying the client VPC, such as an ID of a second virtual network interface card having a one-to-one correspondence with the client VPC.

In a form of implementation, the first or second virtual network interface card device in the embodiment of the present application can employ an elastic network interface (ENI), and the ENI is a virtual network interface card bound to a VPC. For example, the ENI will provide one private network IP address for a target service bound thereto, and this private network IP address does not conflict with IP addresses of service instances in a VPC where the target service is located. Optionally, the private network IP address provided by the ENI for the target service bound thereto can be one IP address in a VPC where this ENI is located. Each ENI can also have a unique ID that is not repeated in different VPCs, a private network IP address of each ENI can be repeated in different VPCs, and an ID and VNI of a VPC are usually not repeated either. In FIG. 1a and FIG. 1b, there is illustrated a virtual network interface card device taken as an ENI. For example, service A1 and service A2 can serve as two instances of the target service; VPC1 is a client VPC that can access service A1 and service A2, VPC1 includes service cluster 11 and service cluster 12; and VPC1 includes an endpoint endpoint1 corresponding to service A1, and the endpoint endpoint1 is hosted by a virtual network interface card device eni-d1; VPC2 further contains an endpoint endpoint2 corresponding to service A2, and the endpoint endpoint2 is hosted by a virtual network interface card device eni-d2; VPC2 and VPC3 are both service VPCs, of which VPC2 is a service VPC responsible for providing service A1, and VPC3 is a service VPC responsible for providing service A2; VPC2 includes service cluster 13 providing service A1 and virtual network interface card device eni-c1 corresponding to service A1, and VPC3 includes service cluster 14 providing service A2 and virtual network interface card device eni-c2 corresponding to service A2. Any service instance in service clusters 11 and 12 in VPC1 can access service A1 through endpoint endpoint1 or virtual network interface card device eni-d1; likewise, any service instance in service clusters 11 and 12 in VPC1 can access service A2 through endpoint endpoint2 or virtual network interface card device eni-d2.

In this embodiment, there is a one-to-one relationship between the services and the virtual network interface card devices, but there is a one-to-many relationship between the virtual network interface card devices and the services. That is to say, each service corresponds to one virtual network interface card device, which is provided with a private network IP address by this virtual network interface card device; however, each virtual network interface card device can be bound to a plurality of services and provide different private network IP addresses for the plurality of services. Taking a target service as an example, in FIG. 1a and FIG. 1b, each service being bound to one virtual network interface card device is taken as an example for illustration. In VPC1 that serves as a client VPC, service A1 is bound to one virtual network interface card device eni-d1, which is responsible for providing a second private network IP address for service A1, and service A2 is bound to one virtual network interface card device eni-d2, which is responsible for providing a second private network IP address for service A2; likewise, in VPC2 that serves as a service VPC, service A1 is bound to one virtual network interface card device eni-c1, which is responsible for providing a first private network IP address for service A1; and in VPC3 that serves as a service VPC, service A2 is bound to one virtual network interface card device eni-c2, which is responsible for providing a first private network IP address for service A2.

In detail, from a perspective of a service VPC, this service VPC can include one first virtual network interface card device, and this first virtual network interface card device serves as a traffic access point of various target services that the service VPC can provide, and provides different private network IP addresses for each target service respectively, so as to distinguish different target services. Alternatively, this service VPC can also include a plurality of first virtual network interface card devices, and each first virtual network interface card device is responsible for serving as a traffic access point of one target service and providing a private network IP address for this target service. Certainly, in a case where the service VPC includes the plurality of first virtual network interface card devices, there may also be a case where some target services need to share a same virtual network interface card device. For the case where the same virtual network interface card device is shared, this shared virtual network interface card device needs to provide different first private network IP addresses for a plurality of target services that share this device, so as to distinguish different target services. It is noted here that, for a case where there is a plurality of target services, the plurality of target services can have an identical first private network IP address, and different target services are distinguished by used port numbers. That is, first private network IP addresses used by the plurality of target services are identical, but port numbers are different. For example, IP address 1+port number 80 indicates one target service, and IP address 1+port number 8080 indicates another target service.

Likewise, in a case where a same client VPC has an access demand for a plurality of target services, in this client VPC, each target service can be bound to a respective second virtual network interface card device respectively, or the plurality of target services can share a same second virtual network interface card device, or some target services can share a same one virtual network interface card device. For a case where a same second virtual network interface card device is bound to the plurality of target services, this second virtual network interface card device can provide different second private network IP addresses for the plurality of target services, so as to distinguish different target services. Certainly, this second virtual network interface card device can also provide an identical second private network IP address for the plurality of target services, and the plurality of target services can be distinguished by using different port numbers.

In an embodiment of the present application, VPCs hosting service clusters are divided into a service VPC for providing a target service externally and a client VPC for accessing the target service, the target service having different service information in the service VPC and the client VPC; further, virtual network interface card devices are added in the service VPC and the client VPC to be responsible for providing service information of the target service respectively, so that a service instance in the client VPC can perform cross-VPC access to the target service in the service VPC through the virtual network interface card devices of the client VPC and the service VPC, which is equivalent to making a layer of isolation for the service information (which mainly refers to a first private network IP address) of the target service in the service VPC, so that a private network IP address of a service instance in the client VPC which has a service access demand and a private network IP address of the target service in the service VPC will not appear in an access request as a source IP address and a destination IP address at the same time. Therefore, whether IP addresses of the client VPC and the service VPC overlap may not be limited, which can effectively isolate the problem of address overlap between the client VPC and the service VPC. That is to say, the IP addresses of the client VPC and the service VPC may overlap, or may not overlap, and these two cases are both applicable to the embodiment of the present application.

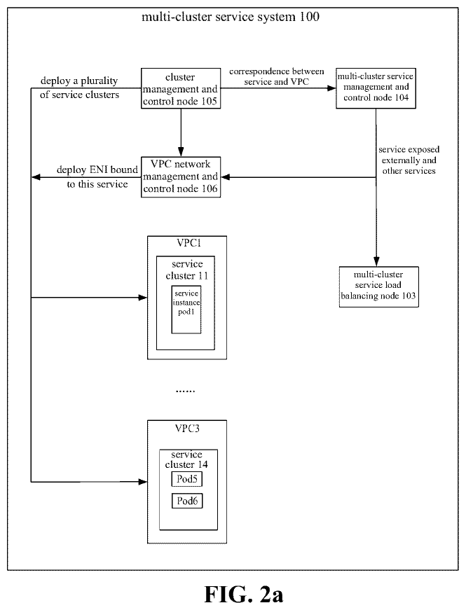

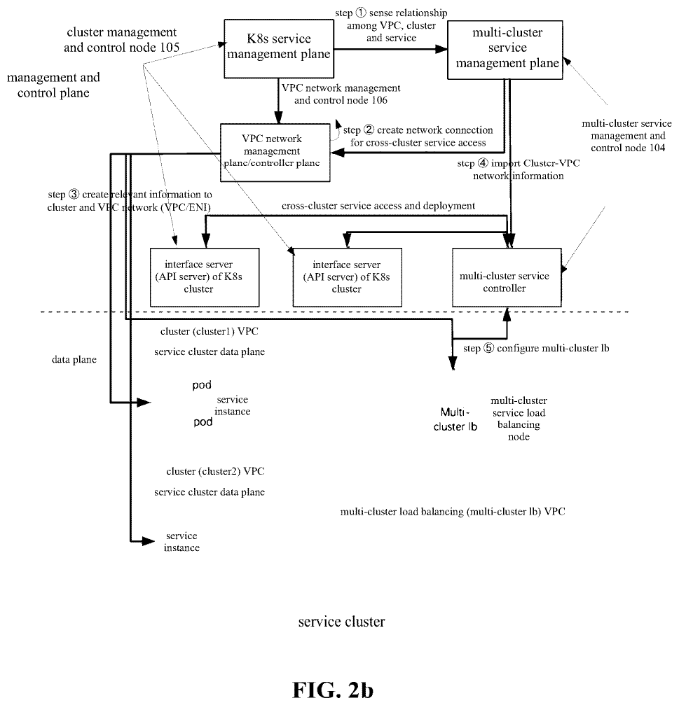

A process of performing service access based on the service information which the target service has in the client VPC and the service VPC can be implemented cooperatively by a multi-cluster load balancing node in a multi-cluster service system 100. Based on this, in this embodiment, in addition to the client VPC and the service VPC, multi-cluster service system 100 further includes a system VPC, in which a multi-cluster load balancing node 103 is further deployed, as shown in FIG. 2a. As shown in FIG. 1a or FIG. 1b, a system VPC being a multi-cluster load balancing (multi-cluster lb) VPC is taken as an example for illustration, where a multi-cluster load balancing node lb1 is deployed in a system VPC in a first region, and a multi-cluster load balancing node lb2 is deployed in a system VPC in a second region, but the present application is not limited to this.

In this embodiment, a multi-cluster load balancing node is networked with virtual network interface card devices in a client VPC and a service VPC in a region to which it belongs, and solid lines indicate networked relationships in FIG. 1a or FIG. 1b. This multi-cluster load balancing node is between the service VPC that exposes a target service externally and the client VPC that requests the target service. Comparatively, the client VPC can be regarded as a frontend of the multi-cluster load balancing node, and the service VPC can be regarded as a backend of the multi-cluster load balancing node. Privatelink of endpoints can be employed between the frontend and the multi-cluster load balancing node, which, in cooperation with the virtual network interface card devices in the frontend and the backend, not only can implement mutual access between multi-cluster services across the VPCs, but also can effectively isolate the problem of address overlap between the client VPC and the service VPC.

In this embodiment, the multi-cluster load balancing node, on the one hand, is used for generating in advance an information mapping relationship among second service information which a target service has in each client VPC, first service information which the target service has in each service VPC, and information of a service instance in each service VPC which can provide the target service. The information mapping relationship includes second service information which the target service has in each client VPC, first service information which the target service has in each service VPC, and information of a service instance in each service VPC which can provide the target service. Further, taking the first service information including a first private network IP address and a port number of the target service, and the second service information including a second private network IP address and a mapped port number of the target service as an example, the information mapping relationship includes the second private network IP address which the target service has in each client VPC and the mapped port number of the target service, the first private network IP address which the target service has in each service VPC and the port number of the target service, and the information of the service instance in each service VPC which can provide the target service. The information of the service instance refers to information that can uniquely identify a service instance that can provide the target service, which at least includes an IP address and a port number of the service instance in the service VPC. The number of service instances in each service VPC which can provide the target service is one or more.

The above information mapping relationship generated in advance by the multi-cluster load balancing node will be exemplarily explained below. Example X1: assuming that a target service exposed externally by a service VPC is service B1, then the service VPC where service B1 is located is VPC-1 and VPC-2, a service instance in VPC-1 which can provide service B1 is pod1, a virtual network interface card device in VPC-1 which serves as a traffic access point of service B1 is ENI1, this ENI1 provides a first private network IP address ENI1-IP for service B1, and service B1 has a port number DI in VPC-1; and a service instance in VPC-2 which can provide service B1 is pod2, a virtual network interface card device in VPC-2 which serves as a traffic access point of service B1 is ENI2, this ENI2 provides a first private network IP address ENI2-IP for service B1, and service B1 has a port number D2 in VPC-2; assuming that a client VPC is VPC-3, a service instance in VPC-3 which needs to access service B1 is pod3, a virtual network interface card device in VPC-3 which is bound to service B1 is ENI3, this ENI3 provides a second private network IP address ENI3-IP for service B1, and service B1 has a port number D3 in VPC-3; one example of an information mapping relationship generated or maintained by the multi-cluster load balancing node is: ENI3-IP/port D3→ENI1-IP/port D1→IP address/port p1 of pod1, and ENI3-IP/port D3→ENI2-IP/port D2→IP address/port p2 of pod2.

In the above example, service B1 is a target service that can be exposed externally, VPC-1 and VPC-2 belong to the above service VPC, and the service instance that is pod3 is any service instance in VPC-3 which has access demand for the target service (i.e., service B1), and VPC-3 belongs to the above client VPC. Any service instance in any service cluster in the client VPC can request a target service exposed externally by the service VPC, and the multi-cluster load balancing node load-balances this access request into a certain target service instance in a certain service VPC which can specifically provide the target service. As can be seen from this, another function of the multi-cluster load balancing node is to assist, based on the information mapping relationship generated in advance, any service instance in a client VPC in completing an access process to a target service, details of which is referred to in the following embodiment.

In this embodiment, in a case where any service instance in any client VPC needs to access a target service, access to the target service can be initiated by accessing a second virtual network interface card device (e.g., ENI) in the client VPC which is bound to the target service. Specifically, any service instance in any client VPC can send an access request through the second virtual network interface card device in the client VPC; after receiving the access request, the multi-cluster load balancing node can load-balance, based on an information mapping relationship generated in advance, the access request for this target service from any client VPC onto a target service instance in at least one service VPC, so as to enable the target service instance to provide the target service for a service instance corresponding to the access request. The target service instance is a certain service instance in a certain service VPC which can provide this target service, which can be specifically determined by a load balancing algorithm employed by the multi-cluster load balancing node. For a load balancing process, reference can be made to a subsequent embodiment, which will not be detailed here. The “service instance corresponding to the access request” mentioned in the embodiments of the present application refers to any service instance in any client VPC which needs to access the target service.

In detail, for a service instance in any client VPC which needs to access a target service, in a case where it needs to access the target service, an access request can be initiated by accessing a second virtual network interface card device (e.g., ENI) in the client VPC where it is located. One implementation where the service instance that needs to access the target service initiates the access request by accessing the second virtual network interface card device (e.g., ENI) in the client VPC where it is located is as follows: a service instance that needs to access a target service directly generates an access request and sends the access request to a second virtual network interface card device (e.g., ENI) in the client VPC where it is located, and the access request is sent by the second virtual network interface card device (e.g., ENI) to the multi-cluster load balancing node. Another implementation where the service instance that needs to access the target service initiates the access request by accessing the second virtual network interface card device (e.g., ENI) in the client VPC where it is located is as follows: a service instance that needs to access a target service generates an initial request, a source IP address of this initial request is an IP address of the service instance that needs to access the target service, and a destination IP address is an IP address of a service cluster where this service instance is located; subsequently, a computing node where this service instance is located replaces, based on a mapping relationship maintained in advance between the IP address of the service cluster and the IP address of the second virtual network interface card device in the client VPC where this service cluster is located, the destination IP address in the initial request with the IP address of the second virtual network interface card device, thereby obtaining the access request, and sends the access request to the second virtual network interface card device, and the second virtual network interface card device (e.g., ENI) sends the access request to the multi-cluster load balancing node.

Regardless of the above implementations, the source IP address of the above access request is an IP address of a service instance in any client VPC which needs to access the target service, the source port number is a random port, the destination IP address is a private network IP address of the second virtual network interface card device, that is, a second private network IP address, and the destination port number is a port number (e.g., 80) of the target service or a mapped port number (e.g., 8080) of the target service. Further, the above access request may also include identification information of the client VPC to which the service instance that initiates this access request belongs, which can be an ID of the client VPC, a VNI in a VXLAN field, or various information that can uniquely identify the client VPC, such as an ID of the second virtual network interface card device corresponding to this client VPC.

The multi-cluster load balancing node determines a target service instance and a target private network IP address according to identification information of any client VPC which is contained in this access request and the second private network IP address which the target service has in this client VPC (i.e., a private network IP address of the second virtual network interface card device in this client VPC), and in conjunction with the above information mapping relationship, and the target private network IP address is a first private network IP address which the target service has in a service VPC where the target service instance is located; and next, sends the above access request to the target service instance according to an IP address of the target service instance and the target private network IP address, so as to enable the target service instance to provide the target service for a service instance corresponding to the above access request.

Further, the above process of determining the target service instance and the target private network IP address is as follows: querying the above information mapping relationship according to the identification information of the client VPC contained in this access request and the second private network IP address, obtaining at least one service VPC that can provide the target service and information of a service instance therein which can provide the target service; determining, in conjunction with a load balancing algorithm, a target service instance from service instances in the at least one service VPC which can provide the target service, and determining a service VPC where the target service instance is located, and using a first private network IP address corresponding to the service VPC where the target service instance is located as a target private network IP address.

Further, the above process of sending the above access request to the target service instance according to the IP address of the target service instance and the target private network IP address includes: converting a source IP address and a destination IP address of the above access request into the target private network IP address and the IP address of the target service instance respectively; and then, sending, via a first virtual network interface card device in the service VPC where the target service instance is located, the access request after address conversion to the target service instance, so as to enable the target service instance to provide the target service for the service instance corresponding to the above access request.

In addition to the above address conversion approach, an address conversion approach provided in the following optional embodiment can also be employed: an address of a system VPC does not overlap with addresses of a client VPC and a service VPC, and an IP address of the multi-cluster load balancing node comes from the IP address of the system VPC. The IP address of the multi-cluster load balancing node will not conflict with an IP address of a target service instance. Then during address conversion, a source IP address of an access request before address conversion is an IP address of a service instance in any client VPC which needs to access a target service, and a destination IP address is a second private network IP address. In a process where address conversion is performed for the access request, the source IP address and destination IP address in the access request can be converted into the IP address of the multi-cluster load balancing node and the IP address of the target service instance respectively, so as to obtain the access request after address conversion. In this implementation, as long as there is no conflict between the address of the system VPC and addresses of other VPCs, access can be implemented between different services, and the addresses of the client VPC and the service VPC may not be limited, allowing address overlap between different VPCs in a case where multi-cluster service access is performed across the VPCs.

In the above embodiments, the target service instance is any service instance in the at least one service VPC. The target service instance and the first virtual network interface card device corresponding to the target private network IP address both belong to a same service VPC. Therefore, no address conflict will occur between the target private network IP address and the IP address of the target service instance. Likewise, the service instance corresponding to the above access request (i.e., a service instance in any client VPC which needs to access the target service) and the second virtual network interface card device both belong to the client VPC, and no address conflict will occur between the second private network IP address carried in the request packet and the IP address of the service instance in the client VPC which needs to access the target service. Further, in an embodiment of the present application, by distinguishing a client VPC from a service VPC, adding a virtual network interface card device (e.g., ENI) to the client VPC and the service VPC respectively, and organizing, on the multi-cluster load balancing node, a first private network IP address of an endpoint/virtual network interface card device in the client VPC, a second private network IP address of a virtual network interface card device in the service VPC, and information of a service instance in the service VPC which provides the target service, and further in conjunction with conversion of the first private network IP address and the second private network IP address, an IP address of a service instance in the client VPC which needs to access the target service and an IP address of a target service instance will not appear in the access request as a source IP address and a destination IP address at the same time, that is to say, the problem of address conflict will not occur. Therefore, whether the IP addresses of the client VPC and the service VPC overlap may not be limited, that is to say, in a case where multi-cluster services are accessed across the VPCs, there may be no requirement on whether the addresses of the client VPC and the service VPC overlap, which solves the problem of address overlap of different VPCs as faced when multi-cluster service access is performed across the VPCs.

Subsequent to the above example X1, a second private network IP address is ENI3-IP, and the above information mapping relationship is queried according to ENI3-IP/port D3,obtaining ENI1-IP/port D1→IP address/port p1 of pod1 and ENI2-IP/port D2→IP address/port p2 of pod2; afterwards, one of pod1 and pod2 can be selected as a target service instance according to a load balancing policy, and assuming that the target service instance is pod1, a target private network IP address corresponding to the target service instance is ENI1-IP. Accordingly, it can be known that pod1 is to be accessed through ENI1that provides ENI1-IP for service B1, so an access request can be sent to pod1 according to information of the two addresses, and finally pod1 provides service B1 for a service instance pod3 in VPC-3.

In an optional embodiment, as shown in FIG. 2a, the multi-cluster service system 100 further includes a multi-cluster service management and control node 104. This multi-cluster service management and control node 104 belongs to a control plane node, which is used for acquiring and delivering second service information which a target service in the multi-cluster service system which can be exposed externally has in each client VPC, first service information which the target service has in each service VPC, and information of a service instance in each service VPC which can provide the target service to a multi-cluster load balancing node, so as to be used by the multi-cluster load balancing node to locally generate the above information mapping relationship.

In this embodiment, the target service can be a containerized service, or can be a virtual machine-based service. For different types of target services, the approach of multi-cluster service management and control node 104 in acquiring various information needed by the information mapping relationship will vary. It will be categorized and explained below:

Case 1: If the target service is a containerized service, then multi-cluster service management and control node 104 can automatically discover, based on a service exposure mechanism of K8s, a target service exposed externally by at least one service VPC, and at least one client VPC which needs to access the target service, configure second service information which the target service has in each client VPC, and acquire, by a cluster management and control node 105 in multi-cluster service system 100 (as shown in FIG. 2a), first service information which the target service has in each service VPC, and information of a service instance in each service VPC which can provide the target service. Further, multi-cluster service management and control node 104, on the one hand, delivers second service information which the target service has in each client VPC, first service information which the target service has in each service VPC, and information of a service instance in each service VPC which can provide the target service to the multi-cluster load balancing node; and on the other hand, also can deploy, according to second service information which the target service has in each client VPC, by a VPC network management and control node 106 in multi-cluster service system 100 shown in FIG. 2a, in each client VPC, an endpoint corresponding to the target service, that is, a second virtual network interface card device. Further, in a case where a first private network IP address of the target service is provided by a first virtual network interface card device, a first virtual network interface card device corresponding to the target service can also be deployed in each service VPC by VPC network management and control node 106.

Cluster management and control node 105 is used for deploying a plurality of service clusters in a plurality of VPCs. Cluster management and control node 105 stores information such as which service clusters are deployed in which VPC, which service instances are deployed in which service cluster, and which services a service cluster can provide externally. That is, it maintains a distribution relationship between the plurality of service clusters and services provided externally by them and the plurality of VPCs, and cluster management and control node 105 can synchronize this distribution relationship to multi-cluster service management and control node 104.

Case 2: In a case where the target service is a virtual machine-based service that does not support an automatic discovery mechanism, then various information needed by the above information mapping relationship can be provided for multi-cluster service management and control node 104 by means of manual configuration to implement injection of the virtual machine-based service. For multi-cluster service management and control node 104, it can receive service configuration information submitted by a user, the service configuration information including information of at least one service VPC where the target service is located, first service information which the target service has in each service VPC, information of a service instance in each service VPC which can provide the target service, and information of each client VPC which needs to access the target service, and second service information which the target service has in each client VPC. Further, multi-cluster service management and control node 104, on the one hand, delivers second service information which the target service has in each client VPC, first service information which the target service has in each service VPC, and information of a service instance in each service VPC which can provide the target service to the multi-cluster load balancing node; and on the other hand, also can deploy, according to second service information which the target service has in each client VPC, by VPC network management and control node 106, in each client VPC, an endpoint corresponding to the target service, that is, a second virtual network interface card device. Further, in a case where a first private network IP address of the target service is provided by a first virtual network interface card device, a first virtual network interface card device corresponding to the target service can also be deployed in each service VPC by VPC network management and control node 106. Accordingly, a traditional cloud service can be simulated in a control plane as a k8s service or integrated into a k8s cluster.

Further, multi-cluster service management and control node 104 also can provide, to cluster management and control node 105, a first private network IP address which the first virtual network interface card device deployed in the service VPC has and a second private network IP address which the second virtual network interface card device deployed in the client VPC has, and cluster management and control node 105 maintains a relationship between the clusters and the virtual network interface card devices from a service cluster dimension, specifically: maintaining a mapping relationship between the first private network IP address of the first virtual network interface card device and IP addresses of service clusters in the service VPC which provide the target service, and maintaining a mapping relationship between the second private network IP address of the second virtual network interface card device and IP addresses of service clusters in the client VPC. Correspondingly, multi-cluster service management and control node 104 also can provide, to VPC network management and control node 106, the first private network IP address which the first virtual network interface card device deployed in the service VPC has and the second private network IP address which the second virtual network interface card device deployed in the client VPC has, and VPC network management and control node 106 maintains a mapping relationship between the VPCs and the virtual network interface card devices from a VPC dimension, specifically: maintaining a mapping relationship between the first private network IP address of the first virtual network interface card device and an IP address of the service VPC, and maintaining a mapping relationship between the second private network IP address of the second virtual network interface card device and an IP address of the client VPC.

In this embodiment, an implementation where the multi-cluster service management and control node deploys the second virtual network interface card device in the client VPC and the first virtual network interface card device in the service VPC through the VPC network management and control node is not limited, which can include: deploying, by employing a static approach in advance, the second virtual network interface card device in each client VPC and deploying the first virtual network interface card device in the service VPC, or, deploying, by employing a dynamic approach in conjunction with a timing of external exposure of the target service, the second virtual network interface card device in the client VPC and deploying the first virtual network interface card device in the service VPC.

Regarding the static approach to deployment: after acquiring information of at least one service VPC that provides a target service externally, the multi-cluster service management and control node deploys a first virtual network interface card device in each service VPC in advance through the VPC network management and control node. This approach to deployment does not need to pay attention to whether the target service is exposed externally, nor does it need to pay attention to a time of external exposure of the target service. Likewise, after acquiring information of a client VPC that needs to access the target service and second service information that the target service has in each client VPC, the multi-cluster service management and control node deploys an endpoint corresponding to the target service in each client VPC, that is, a second virtual network interface card device, in each client VPC in advance through the VPC network management and control node. This approach to deployment does not need to pay attention to whether the target service is exposed externally, nor does it need to pay attention to a time of external exposure of the target service.

Regarding the dynamic approach to deployment: the multi-cluster service management and control node has a service monitoring and discovery mechanism, and can, based on this, deploy a first virtual network interface card device in each service VPC through the VPC network management and control node when discovering that the service VPC exposes a target service externally; and correspondingly can configure, upon automatically discovering information of a client VPC that needs to access the target service, second service information that the target service has in each client VPC, and according to this, deploy an endpoint corresponding to the target service, i.e., a second virtual network interface card device, in each client VPC through the VPC network management and control node. The endpoint is associated with the target service, and can establish a privatelink with the multi-cluster load balancing node, so as to access the target service through this privatelink and ensure the security of access to the target service.

The endpoint is a node deployed in a client VPC and corresponding to a target service. Based on that this endpoint can interact with the multi-cluster load balancing node through a privatelink, this, in turn, implements service access based on a private network, which, compared with service access based on a public network, can improve the security of service access, save resources such as an IP address of the public network, and reduce service access costs. Since there is a correspondence between the endpoint and the target service, in a case where this endpoint accesses the multi-cluster load balancing node through the private link, the multi-cluster load balancing node can determine the target service corresponding to this endpoint, and, in turn, determine service instances in the service VPC which can provide the target service, and the multi-cluster load balancing node routes an access request to a finally selected target service instance according to a load balancing policy. For the content about the load balancing policy, reference can be made to a subsequent embodiment, which will not be repeated here.

In the foregoing or the following embodiments of the present application, the multi-cluster load balancing node can generate in advance or maintain an information mapping relationship among second service information which a target service has in each client VPC, first service information which the target service has in each service VPC, and information of a service instance in each service VPC which can provide the target service. In an optional embodiment, the multi-cluster load balancing node may not provide any service, and therefore can directly maintain the information mapping relationship among second service information which the target service has in each client VPC, first service information which the target service has in each service VPC, and information of a service instance in each service VPC which can provide the target service.

In another optional embodiment, a third virtual network interface card device bound to a target service is deployed in a system VPC where the multi-cluster load balancing node is located, and the third virtual network interface card device has a third private network IP address. The third virtual network interface card device can be a virtual network interface card device which the system VPC uses, can be shared by different target services, and can provide different private network IP addresses for different target services, or can also be a virtual network interface card device separately deployed for a target service and specifically responsible for providing a private network IP address for the target service. The third private network IP address is a virtual IP address capable of uniquely identifying a target service, which is also referred to as a VIP. Third service information which a target service has in the system VPC includes a third private network IP address and a port number of the target service, which are used to identify and distinguish the target service. Based on this, through the third service information which the target service has in the system VPC, an information mapping relationship can be established among second service information which the target service has in each client VPC, first service information which the target service has in each service VPC, and information of a service instance in each service VPC which can provide the target service.

Specifically, a first information mapping relationship can be established between the third service information which the target service has in the system VPC and first service information which the target service has in each service VPC and information of a service instance in each service VPC which can provide the target service; and a second information mapping relationship can be established between the third service information which the target service has in the system VPC and second service information which the target service has in each client VPC.

In detail, the first information mapping relationship includes: the third private network IP address (i.e., VIP) in the system VPC/a port number of the target service, a second private network IP address of the target service in each service VPC/a port number of the target service, and an IP address/port number of a service instance in each service VPC which can provide the target service. For ease of description, a second private network IP address of the target service in each service VPC/a port number of the target service, and an IP address/port number of a service instance in each service VPC which can provide the target service are referred to as real server (RS) information, and the third private network IP address in the system VPC is indicated by VIP information, and then the first information mapping relationship can be indicated as VIP information/service port number-RS information. The first information mapping relationship includes: the third private network IP address (i.e., VIP) in the system VPC/a port number of the target service, and a second private network IP address of the target service in each client VPC/a port number or a mapped port number of the target service.

As shown in FIG. 1a, taking service A1 that serves as a target service as an example, eni-b1 bound to service A1 is created in the system VPC where the multi-cluster load balancing node is located, service A1 is located in service cluster 13 in VPC2, the port number of service A1 is P1, and ENI information in VPC2 that serves as a service VPC is eni-c1, and then RS information of service A1 is recorded as RSI: service A1-VPC2/pod3/eni-c1, and RS2: service A1-VPC2 is/pod4/eni-c1, and then a first mapping relationship includes: VIP: eni-b1/port number P1→RS1: service A1-VPC2/pod3/eni-c1/port number P1; VIP: eni-b1/port number P1→RS2: service A1-VPC2/pod4/eni-c1/port number P1pod4. Assuming that Port D1 in service cluster 11 in VPC1 that serves as a client VPC serves as a client of service A1, a mapped port number of service A1 in VPC1 is P2, ENI information in VPC1 is eni-d1, and this eni-dl carries endpoint endpoint1 corresponding to service A1, and then a second information mapping relationship includes VIP: eni-b1/port number P1→VPC1: endpoint1/eni-d1/port number P2.

The multi-cluster load balancing node also can create a listener for the target service, which is used for listening to the port number of the target service. Certainly, the port number can also be empty by default, or all port numbers can be legal by default.

In this embodiment, based on the above first information mapping relationship and second information mapping relationship, as shown in FIG. 1a, in a case where service DI needs to access service A1, service instance pod1 sends an access request by accessing eni-d1 in VPC1, and provides this access request to lb1 node through a privatelink between endpoint1 and lb1 node, and a listener of lb1 node listens to an access request from endpoint1, this access request containing an IP address of eni-d1 or endpoint1; according to the second information mapping relationship, eni-b1 that has a mapping relationship with eni-d1 or endpoint1 is determined, then the first information mapping relationship is queried according to eni-b1 to determine service instances pod3 and pod4 which can provide service A1, and eni-c1 in VPC2, and one of pod3 and pod4 is finally selected as a target service instance through load balancing; taking pod3 as selected as an example, then a source IP address of the access request is converted into an IP address of eni-c1, a destination IP address is converted into an IP address of pod3, and the access request after address conversion is provided for pod3 through eni-c1 in VPC2, so as to enable pod3 to provide service A1 for pod1, achieving the purpose of access of pod1 to service A1. In FIG. 1a, a process of accessing service A1 by service D1 is indicated by a dashed line.

In an embodiment of the present application, structures of implementation of cluster management and control node 105 and multi-cluster service management and control node 104 are not limited. In an optional embodiment, cluster management and control node 105 includes: a cluster service management plane and a cluster interface server. As shown in FIG. 2b, taking a K8s cluster as an example, the cluster service management plane can be implemented as a K8s service management plane, and the cluster interface server may be implemented as an interface server (API server) of the K8s cluster, for example, an interface server of K8s cluster 1 and an interface server of K8s cluster 2. Further, as shown in FIG. 2b, multi-cluster service management and control node 104 can include a multi-cluster service management plane and a multi-cluster service controller, and VPC network management and control node 106 can also be referred to as a VPC network management plane/controller plane.

The cluster service management plane is mainly used for deploying a plurality of service clusters in at least one VPC. In FIG. 2b, two service clusters cluster1 and cluster2 being deployed in one VPC is taken as an example for illustration. As shown in step \textcircled{1} in FIG. 2b, the cluster service management plane provides, for the multi-cluster service management plane, a plurality of service clusters, services provided externally by the same, and a correspondence with at least one VPC; as shown in step \textcircled{2} in FIG. 2b, the multi-cluster service management plane creates a network connection for cross-cluster service access; as shown in step \textcircled{3} in FIG. 2b, the multi-cluster service management plane provides, for the VPC network management plane/controller plane, the services provided externally by the plurality of service clusters and the corresponding relationship with the at least one VPC, and deploys, in a VPC where each service is located, ENI bound to this service through the VPC network management plane/controller plane; as shown in step \textcircled{4} in FIG. 2b, the multi-cluster service management plane imports network information of Cluster-VPC into the multi-cluster service controller, where the network information of Cluster-VPC refers to which subnets in VPC can be used, which IP addresses in the subnets can be used, and an IP address allocated to ENI in VPC; as shown in step \textcircled{5} in FIG. 2b, the multi-cluster service controller is used for discovering each service in this multi-cluster service system which can be exposed externally and other services which have access demands for this service, and delivering information of each service and information of other services corresponding thereto to the multi-cluster load balancing node.

As can be known from the above, in this embodiment, through mutual cooperation of the multi-cluster service management and control node, the cluster management and control node, and the VPC network management and control node, multi-cluster service information and relevant information of a VPC where a multi-service cluster is located can be integrated, multi-cluster service access can be organically and automatically combined with a carrier network VPC involved in the multi-cluster service access, and automatic registration and discovery of the multi-cluster service, as well as automatic network connection between carrier network VPCs involved in different service clusters, can be completed, which does not need to manually configure a network connection between VPCs in advance, improves the degree of automation of the multi-cluster service system, and improves the efficiency of the multi-cluster service access.

In an optional embodiment, a plurality of service clusters is carried on a plurality of VPCs that are distributed in different regions, and there is a plurality of service VPCs that provide a target service and are distributed in different regions. As shown in FIG. 1b, assuming that service A1 is a target service, service A1 is located in the first region and the second region, which is specifically located in VPC2 in the first region and VPC4 in the second region, and VPC2 and VPC4 are service VPCs that provide service A1, and pod3 and pod4 in VPC2 are responsible for providing service A1, and pod7 and pod8 in VPC4 are responsible for providing service A1; and VPC2 and VPC4 are two cross-region VPCs where the target service is located. In FIG. 1b, a process where service D1 accesses service A1 is exemplified by a process where pod1 accesses pod7, and a dashed line is used to indicate this access process. In a case where the target service is located in a plurality of service VPCs distributed in different regions, the multi-cluster load balancing node can perform load balancing according to regions where the plurality of service VPCs are located and/or the number of service instances included which can provide the target service, and determine, from the plurality of service VPCs, a target service instance which finally provides the target service. Specifically:

In an optional embodiment, load balancing weights corresponding to the plurality of service VPCs are determined according to regions where the plurality of service VPCs are located; and according to the load balancing weights corresponding to the plurality of service VPCs, the target service instance is determined from service instances in the plurality of service VPCs which can provide the target service. In an optional embodiment, a larger load balancing weight of a service VPC indicates better quality of a service instance in this service VPC, for example, a higher network quality or a lighter load, and the service instance in the service VPC can be preferentially selected as the target service instance. It should be noted that the weight of the service VPC can be flexibly adjusted according to an application demand. For example, in a case where a local VPC needs to be upgraded, a remote service VPC can be set to have a higher load weight, to facilitate preferable selection of the remote service VPC to perform a service.

Optionally, load balancing weights corresponding to the plurality of service VPCs are determined according to a location relationship between regions where the plurality of service VPCs are located and a region where the multi-cluster load balancing node is located. For example, a load balancing weight of a service VPC located in a same region as the multi-cluster load balancing node is greater than a load balancing weight of a service VPC located in a different region from the multi-cluster load balancing node. Further, for service VPCs located in a same region as the multi-cluster load balancing node, load balancing weights of these service VPCs can be determined according to a distance between the region where the service VPCs are located and a region where a client VPC is located; the closer the distance between the region where the service VPCs are located and the region where the client VPC is located is, the greater the load balancing weights of the service VPCs are. In this way, an effect of providing a service nearby can be achieved, which is beneficial to reducing a service delay.

In another optional embodiment, load balancing weights corresponding to the plurality of service VPCs can be determined according to the number of service instances included in the plurality of service VPCs. For example, the more the number of service instances included in the service VPCs is, the greater the load balancing weights are; the less the number of service instances included in the service VPCs is, the smaller the load balancing weights are; and the target service instance is, in turn, determined from the service instances in the service VPCs according to the load balancing weights corresponding to the plurality of service VPCs.

In a further optional embodiment, load balancing weights corresponding to the plurality of service VPCs can be determined according to regions where the plurality of service VPCs are located and the number of service instances included. For example, initial load balancing weights corresponding to the plurality of service VPCs are determined according to a distance between the regions where the service VPCs are located and a region where a client VPC is located; and then according to the number of service instances included in the plurality of service VPCs, the initial load balancing weights of service VPCs in a same region are adjusted to determine the load balancing weights corresponding to the service VPCs in the same region; and the target service instance is determined from a second service instance in the plurality of service VPCs according to the load balancing weights corresponding to the service VPCs in the same region.

The load balancing approach is described in detail above by taking a plurality of service VPCs located in different regions as an example, and the relevant load balancing approaches or improvement solutions thereof are also applicable to a case where the plurality of service VPCs are located in a same region. For example, for the case where the plurality of service VPCs are in the same region, load balancing weights corresponding to the plurality of service VPCs can be determined according to a distance between the region where the plurality of service VPCs are located and a region where a client VPC is located and/or the number of service instances included; and the target service instance is, in turn, determined from service instances in the plurality of service VPCs according to the load balancing weights corresponding to the plurality of service VPCs.

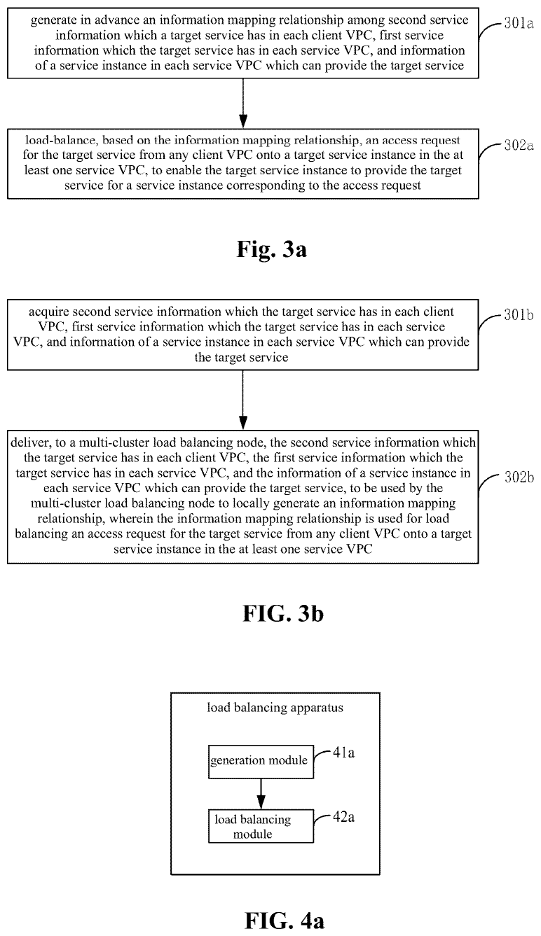

In addition to the above system embodiments, an embodiment of the present application further provides a service access method. FIG. 3a is a schematic flow chart of a service access method provided in an exemplary embodiment of the present application. This method is applicable to a multi-cluster load balancing node in a multi-cluster service system including at least one service VPC responsible for providing a target service and at least one client VPC which can access the target service, as shown in FIG. 3a, this method including:

301a, generating in advance an information mapping relationship among second service information which a target service has in each client VPC, first service information which the target service has in each service VPC, and information of a service instance in each service VPC which can provide the target service; and

302a, load-balancing, based on the information mapping relationship, an access request for the target service from any client VPC onto a target service instance in the at least one service VPC, to enable the target service instance to provide the target service for a service instance corresponding to the access request.

In an optional embodiment, a first virtual network interface card device is deployed in each service VPC as a traffic access point of a target service, the first virtual network interface card device has a first private network IP address, and first service information which the target service has in this service VPC includes the first private network IP address and a port number of the target service.

In an optional embodiment, a second virtual network interface card device bound to the target service is deployed in each client VPC as a traffic routing point of the target service, the second virtual network interface card device has a second private network IP address, and second service information which the target service has in this client VPC includes the second private network IP address and a port number or mapped port number of the target service.

In an optional embodiment, load-balancing, based on the information mapping relationship, the access request for the target service from the any client VPC onto the target service instance in the at least one service VPC, to enable the target service instance to provide the target service for the service instance corresponding to the access request, includes: receiving an access request sent by any service instance in any client VPC through access to a second virtual network interface card device in the client VPC, wherein the access request includes identification information of the any client VPC and a second private network IP address which the second virtual network interface card device has; determining, according to the identification information of the any client VPC and the second private network IP address, in conjunction with the information mapping relationship, a target service instance and a target private network IP address, wherein the target private network IP address is a first private network IP address which the target service has in a first virtual network interface card device in a service VPC where the target service instance is located; and sending, according to an IP address of the target service instance and the target private network IP address, the access request to the target service instance, to enable the target service instance to provide the target service for a service instance corresponding to the access request. The above service instance corresponding to the access request refers to a service instance in any client VPC which needs to access the target service, that is, a service instance that sends the access request through access to the second virtual network interface card device in this client VPC.

In an optional embodiment, sending, according to the IP address of the target service instance and the target private network IP address, the access request to the target service instance, to enable the target service instance to provide the target service for the service instance corresponding to the access request, includes: converting a source IP address and a destination IP address of the access request into the target private network IP address and an IP address of the target service instance, respectively; and sending, via a first virtual network interface card device in a service VPC where the target service instance is located, the access request after address conversion to the target service instance, to enable the target service instance to provide the target service for a service instance corresponding to the access request.

In an optional embodiment, the at least one service VPC includes a plurality of service VPCs distributed in different regions, and determining the target service instance according to the identification information of the any client VPC and the second private network IP address, in conjunction with the information mapping relationship, includes: acquiring, according to the identification information of the any client VPC and the second private network IP address in conjunction with the information mapping relationship, the plurality of service VPCs and information of a service instance therein which can provide the target service; determining, according to regions where the plurality of service VPCs are located and/or the number of service instances contained which can provide the target service, load balancing weights corresponding to the plurality of service VPCs; and determining, according to the load balancing weights corresponding to the plurality of service VPCs, the target service instance from service instances in the plurality of service VPCs which can provide the target service.

In an optional embodiment, determining, according to the regions where the plurality of service VPCs are located, the load balancing weights corresponding to the plurality of service

VPCs, includes: determining, according to a location relationship between regions where the plurality of service VPCs are located and a region where the multi-cluster load balancing node is located, load balancing weights corresponding to the plurality of service VPCs; wherein a load balancing weight of a service VPC located in a same region as the multi-cluster load balancing node is greater than a load balancing weight of a service VPC located in a different region from the multi-cluster load balancing node.

In an optional embodiment, generating in advance the information mapping relationship among second service information which the target service has in each client VPC, first service information which the target service has in each service VPC, and information of a service instance in each service VPC which can provide the target service, includes: deploying, in a system VPC where the multi-cluster load balancing node is located, a third virtual network interface card device bound to the target service, wherein the third virtual network interface card has a third private network IP address, and third service information which the target service has in the system VPC includes the third private network IP address and a port number of the target service; and establishing, through the third service information which the target service has in the system VPC, an information mapping relationship among second service information which the target service has in each client VPC, first service information which the target service has in each service VPC, and information of a service instance in each service VPC which can provide the target service.

Optionally, according to the third service information which the target service has in the system VPC, the above information mapping relationship can be split into two parts: a first information mapping relationship and a second information mapping relationship. Specifically, the first information mapping relationship can be created between the third service information which the target service has in the system VPC and first service information which the target service has in each service VPC and information of a service instance in each service VPC which can provide the target service; and the second information mapping relationship can be created between the third service information which the target service has in the system VPC and second service information which the target service has in each client VPC.

FIG. 3b is a schematic flow chart of an information configuration method provided in an exemplary embodiment of the present application, and this method is applicable to a multi-cluster service management and control node in a multi-cluster service system including at least one service VPC responsible for providing a target service and at least one client VPC which can access the target service, as shown in FIG. 3b, this method including:

301b, acquiring second service information which the target service has in each client VPC, first service information which the target service has in each service VPC, and information of a service instance in each service VPC which can provide the target service; and

302b: delivering, to a multi-cluster load balancing node, the second service information which the target service has in each client VPC, the first service information which the target service has in each service VPC, and the information of a service instance in each service VPC which can provide the target service, to be used by the multi-cluster load balancing node to locally generate an information mapping relationship, wherein the information mapping relationship is used for load balancing an access request for the target service from any client VPC onto a target service instance in the at least one service VPC.

In an optional embodiment, acquiring the second service information which the target service has in each client VPC, the first service information which the target service has in each service VPC, and the information of the service instance in each service VPC which can provide the target service, includes: automatically discovering, in a case where the target service is a containerized service, based on a service exposure mechanism, a target service exposed externally by the at least one service VPC, and at least one client VPC which needs to access the target service, configuring second service information which the target service has in each client VPC, and acquiring, by a cluster management and control node, the first service information which the target service has in each service VPC, and the information of a service instance in each service VPC which can provide the target service; or receiving, in a case where the target service is a virtual machine-based service, service configuration information submitted by a user, wherein the service configuration information includes information of at least one service VPC where the target service is located, the first service information which the target service has in each service VPC, the information of a service instance in each service VPC which can provide the target service, and information of each client VPC which needs to access the target service, and the second service information which the target service has in each client VPC.

In an optional embodiment, the method provided in the embodiment of the present application further includes: deploying, according to the second service information which the target service has in each client VPC, by a VPC network management and control node, in each client VPC, an endpoint corresponding to the target service, that is, a second virtual network interface card device. Further, in a case where a first private network IP address of the target service is provided by a first virtual network interface card device, a first virtual network interface card device corresponding to the target service can also be deployed in each service VPC through the VPC network management and control node.

It should be noted that, an execution subject of respective steps of the methods provided in the above embodiments can be a same device, or different devices are used as an execution subject of the methods. For example, an execution subject of step 301a to step 302a can be device A; for another example, an execution subject of step 301a can be device A, and an execution subject of step 302a can be device B; and the like.

Additionally, in some flows described in the above embodiments and drawings, a plurality of operations that appear in a particular sequence are contained, but it should be clearly understood that these operations may not be executed in the sequence in which they appear herein, or executed in parallel. Sequence numbers of the operations, such as 301a and 302a, are only used to distinguish different operations, and the sequence numbers themselves do not represent any execution sequence. Additionally, these flows can include more or fewer operations, and these operations can be executed in sequence or in parallel. It should be noted that descriptions such as “first” and “second” herein are used to distinguish different messages, devices, modules, and the like, which do not represent a sequence, or limit “first” and “second” to be different types.

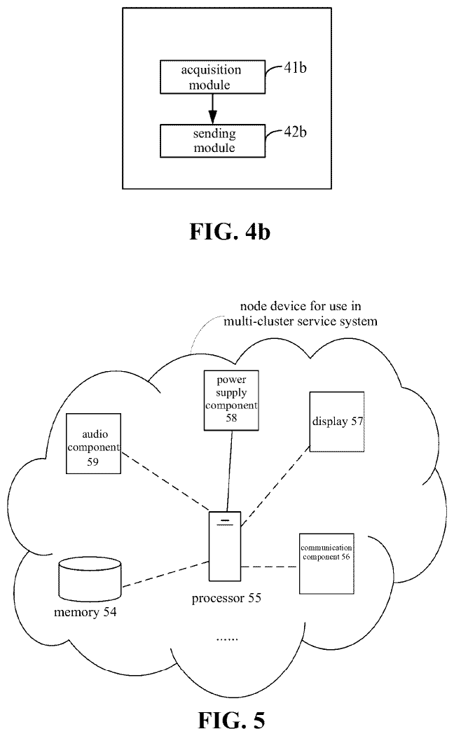

FIG. 4a is a schematic structural diagram of a load balancing apparatus provided in an exemplary embodiment of the present application, and this apparatus can be implemented as a multi-cluster load balancing node in a multi-cluster service system including at least one service VPC responsible for providing a target service and at least one client VPC which can access the target service, as shown in FIG. 4a, this apparatus including: a generation module 41a and a load balancing module 42a.

Generation module 41a is used for generating in advance an information mapping relationship among second service information which a target service has in each client VPC, first service information which the target service has in each service VPC, and information of a service instance in each service VPC which can provide the target service; and

Load balancing module 42a is used for load-balancing, based on the information mapping relationship, an access request for the target service from any client VPC onto a target service instance in the at least one service VPC, to enable the target service instance to provide the target service for a service instance corresponding to the access request.

In an optional embodiment, a first virtual network interface card device is deployed in each service VPC as a traffic access point of a target service, the first virtual network interface card device has a first private network IP address, and first service information which the target service has in this service VPC includes the first private network IP address and a port number of the target service.

In an optional embodiment, a second virtual network interface card device bound to the target service is deployed in each client VPC as a traffic routing point of the target service, the second virtual network interface card device has a second private network IP address, and second service information which the target service has in this client VPC includes the second private network IP address and a port number or mapped port number of the target service.

In an optional embodiment, load balancing module 42a is specifically used for: receiving an access request sent by any service instance in any client VPC through access to a second virtual network interface card device in the client VPC, wherein the access request includes identification information of the any client VPC and a second private network IP address which the second virtual network interface card device has; determining, according to the identification information of the any client VPC and the second private network IP address, in conjunction with the information mapping relationship, a target service instance and a target private network IP address, wherein the target private network IP address is a first private network IP address which the target service has in a first virtual network interface card device in a service VPC where the target service instance is located; and sending, according to an IP address of the target service instance and the target private network IP address, the access request to the target service instance, to enable the target service instance to provide the target service for a service instance corresponding to the access request.

In an optional embodiment, load balancing module 42a is specifically used for: converting a source IP address and a destination IP address of the access request into the target private network IP address and an IP address of the target service instance, respectively; and sending, via a first virtual network interface card device in a service VPC where the target service instance is located, the access request after address conversion to the target service instance, to enable the target service instance to provide the target service for a service instance corresponding to the access request.

In an optional embodiment, the at least one service VPC includes a plurality of service VPCs distributed in different regions, and load balancing module 42a is specifically used for: acquiring, according to the identification information of the any client VPC and the second private network IP address in conjunction with the information mapping relationship, the plurality of service VPCs and information of a service instance therein which can provide the target service; determining, according to regions where the plurality of service VPCs are located and/or the number of service instances contained which can provide the target service, load balancing weights corresponding to the plurality of service VPCs; and determining, according to the load balancing weights corresponding to the plurality of service VPCs, the target service instance from service instances in the plurality of service VPCs which can provide the target service.

In an optional embodiment, load balancing module 42a is specifically used for: determining, according to a location relationship between regions where the plurality of service VPCs are located and a region where the multi-cluster load balancing node is located, load balancing weights corresponding to the plurality of service VPCs; wherein a load balancing weight of a service VPC located in a same region as the multi-cluster load balancing node is greater than a load balancing weight of a service VPC located in a different region from the multi-cluster load balancing node.

In an optional embodiment, generating module 41a is specifically used for: deploying, in a system VPC where the multi-cluster load balancing node is located, a third virtual network interface card device bound to the target service, wherein the third virtual network interface card has a third private network IP address, and third service information which the target service has in the system VPC includes the third private network IP address and a port number of the target service; and establishing, through the third service information which the target service has in the system VPC, an information mapping relationship among second service information which the target service has in each client VPC, first service information which the target service has in each service VPC, and information of a service instance in each service VPC which can provide the target service.

Optionally, according to the third service information which the target service has in the system VPC, the above information mapping relationship can be split into two parts: a first information mapping relationship and a second information mapping relationship. Specifically, the first information mapping relationship can be created between the third service information which the target service has in the system VPC and first service information which the target service has in each service VPC and information of a service instance in each service VPC which can provide the target service; and the second information mapping relationship can be created between the third service information which the target service has in the system VPC and second service information which the target service has in each client VPC.

FIG. 4b is a schematic structural diagram of a management and control apparatus in a multi-cluster service system provided in an exemplary embodiment of the present application, and this apparatus can be implemented as a multi-cluster service management and control node in the multi-cluster service system including at least one service VPC responsible for providing a target service and at least one client VPC which can access the target service, as shown in FIG. 4b, this apparatus including an acquisition module 41b and a sending module 42b.

Acquisition module 41b is used for acquiring second service information which the target service has in each client VPC, first service information which the target service has in each service VPC, and information of a service instance in each service VPC which can provide the target service; and
sending module 42b is used for delivering, to a multi-cluster load balancing node, the second service information which the target service has in each client VPC, the first service information which the target service has in each service VPC, and the information of a service instance in each service VPC which can provide the target service, to be used by the multi-cluster load balancing node to locally generate an information mapping relationship, wherein the information mapping relationship is used for load balancing an access request for the target service from any client VPC onto a target service instance in the at least one service VPC.

In an optional embodiment, acquisition module 41b is specifically used for: automatically discovering, in a case where the target service is a containerized service, based on a service exposure mechanism, a target service exposed externally by the at least one service VPC, and at least one client VPC which needs to access the target service, configuring second service information which the target service has in each client VPC, and acquiring, by a cluster management and control node, first service information which the target service has in each service VPC, and information of a service instance in each service VPC which can provide the target service; or receiving, in a case where the target service is a virtual machine-based service, service configuration information submitted by a user, wherein the service configuration information includes information of at least one service VPC where the target service is located, first service information which the target service has in each service VPC, information of a service instance in each service VPC which can provide the target service, and information of each client VPC which needs to access the target service, and second service information which the target service has in each client VPC.

In an optional embodiment, the management and control apparatus further includes a deployment module, the deployment module used for deploying, according to second service information which the target service has in each client VPC, by a VPC network management and control node, in each client VPC, an endpoint corresponding to the target service, that is, a second virtual network interface card device. Further, in a case where a first private network IP address of the target service is provided by a first virtual network interface card device, a first virtual network interface card device corresponding to the target service can also be deployed in each service VPC through the VPC network management and control node.

FIG. 5 is a schematic structural diagram of a node device for use in a multi-cluster service system provided in an exemplary embodiment of the present application, and this node device can be implemented as a multi-cluster load balancing node and a multi-cluster service management and control node of the multi-cluster service system including at least one service VPC responsible for providing a target service and at least one client VPC which can access the target service, as shown in FIG. 5, this node device including: a memory 54 and a processor 55.

Memory 54 is used for storing a computer program and can be configured to store various other data to support operations on the node device. Examples of these data include instructions for any application or method operating on the node device, contact data, phone book data, messages, pictures, videos, and the like.

Memory 54 can be implemented by any type or combination of volatile or non-volatile memory devices, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

In a case where this node device is implemented as a multi-cluster load balancing node, processor 55, coupled to memory 54, is used for executing the computer program in memory 54, so as to be used for: generating in advance an information mapping relationship among second service information which a target service has in each client VPC, first service information which the target service has in each service VPC, and information of a service instance in each service VPC which can provide the target service; and load-balancing, based on the information mapping relationship, an access request for the target service from any client VPC onto a target service instance in the at least one service VPC, to enable the target service instance to provide the target service for a service instance corresponding to the access request.

In an optional embodiment, a first virtual network interface card device is deployed in each service VPC as a traffic access point of a target service, the first virtual network interface card device has a first private network IP address, and first service information which the target service has in this service VPC includes the first private network IP address and a port number of the target service.

In an optional embodiment, a second virtual network interface card device bound to the target service is deployed in each client VPC as a traffic routing point of the target service, the second virtual network interface card device has a second private network IP address, and second service information which the target service has in this client VPC includes the second private network IP address and a port number or mapped port number of the target service.

In an optional embodiment, when load-balancing, based on the information mapping relationship, the access request for the target service from the any client VPC onto the target service instance in the at least one service VPC, to enable the target service instance to provide the target service for the service instance corresponding to the access request, processor 55 is specifically used for: receiving an access request sent by any service instance in any client VPC through access to a second virtual network interface card device in the client VPC, wherein the access request includes identification information of the any client VPC and a second private network IP address which the second virtual network interface card device has; determining, according to the identification information of the any client VPC and the second private network IP address, in conjunction with the information mapping relationship, a target service instance and a target private network IP address, wherein the target private network IP address is a first private network IP address which the target service has in a first virtual network interface card device in a service VPC where the target service instance is located; and sending, according to an IP address of the target service instance and the target private network IP address, the access request to the target service instance, so as to enable the target service instance to provide the target service for a service instance corresponding to the access request.

In an optional embodiment, when sending, according to the IP address of the target service instance and the target private network IP address, the access request to the target service instance, to enable the target service instance to provide the target service for the service instance corresponding to the access request, processor 55 is specifically used for: converting a source IP address and a destination IP address of the access request into the target private network IP address and an IP address of the target service instance, respectively; and sending, via a first virtual network interface card device in a service VPC where the target service instance is located, the access request after address conversion to the target service instance, to enable the target service instance to provide the target service for a service instance corresponding to the access request.

In an optional embodiment, the at least one service VPC includes a plurality of service VPCs distributed in different regions, and when determining the target service instance according to the identification information of the any client VPC and the second private network IP address, in conjunction with the information mapping relationship, processor 55 is specifically used for: acquiring, according to the identification information of the any client VPC and the second private network IP address in conjunction with the information mapping relationship, the plurality of service VPCs and information of a service instance therein which can provide the target service; determining, according to regions where the plurality of service VPCs are located and/or the number of service instances contained which can provide the target service, load balancing weights corresponding to the plurality of service VPCs; and determining, according to the load balancing weights corresponding to the plurality of service VPCs, the target service instance from service instances in the plurality of service VPCs which can provide the target service.

In an optional embodiment, when determining, according to the regions where the plurality of service VPCs are located, the load balancing weights corresponding to the plurality of service VPCs, processor 55 is specifically used for: determining, according to a location relationship between regions where the plurality of service VPCs are located and a region where the multi-cluster load balancing node is located, load balancing weights corresponding to the plurality of service VPCs; wherein a load balancing weight of a service VPC located in a same region as the multi-cluster load balancing node is greater than a load balancing weight of a service VPC located in a different region from the multi-cluster load balancing node.

In an optional embodiment, when generating in advance the information mapping relationship among second service information which the target service has in each client VPC, first service information which the target service has in each service VPC, and information of a service instance in each service VPC which can provide the target service, processor 55 is specifically used for: deploying, in a system VPC where the multi-cluster load balancing node is located, a third virtual network interface card device bound to the target service, wherein the third virtual network interface card has a third private network IP address, and third service information which the target service has in the system VPC includes the third private network IP address and a port number of the target service; and establishing, through the third service information which the target service has in the system VPC, an information mapping relationship among second service information which the target service has in each client VPC, first service information which the target service has in each service VPC, and information of a service instance in each service VPC which can provide the target service.

Optionally, according to the third service information which the target service has in the system VPC, the above information mapping relationship can be split into two parts: a first information mapping relationship and a second information mapping relationship. Specifically, the first information mapping relationship can be created between the third service information which the target service has in the system VPC and first service information which the target service has in each service VPC and information of a service instance in each service VPC which can provide the target service; and the second information mapping relationship can be created between the third service information which the target service has in the system VPC and second service information which the target service has in each client VPC.

In a case where this node device is implemented as a multi-cluster service management and control node, processor 55 executes the computer program stored in memory 54, which can be used for: acquiring and delivering second service information which the target service has in each client VPC, first service information which the target service has in each service VPC, and information of a service instance in each service VPC which can provide the target service to a multi-cluster load balancing node, to be used by the multi-cluster load balancing node to locally generate an information mapping relationship; wherein the information mapping relationship is used for load balancing an access request for the target service from any client VPC onto a target service instance in the at least one service VPC.

In an optional embodiment, when acquiring the second service information which the target service has in each client VPC, the first service information which the target service has in each service VPC, and the information of the service instance in each service VPC which can provide the target service, the processor is specifically used for: automatically discovering, in a case where the target service is a containerized service, based on a service exposure mechanism, a target service exposed externally by the at least one service VPC, and at least one client VPC which needs to access the target service, configuring second service information which the target service has in each client VPC, and acquiring, by a cluster management and control node, first service information which the target service has in each service VPC, and information of a service instance in each service VPC which can provide the target service; or receiving, in a case where the target service is a virtual machine-based service, service configuration information submitted by a user, wherein the service configuration information includes information of at least one service VPC where the target service is located, first service information which the target service has in each service VPC, information of a service instance in each service VPC which can provide the target service, and information of each client VPC which needs to access the target service, and second service information which the target service has in each client VPC.

In an optional embodiment, the processor is further used for: deploying, according to second service information which the target service has in each client VPC, by a VPC network management and control node, in each client VPC, an endpoint corresponding to the target service, that is, a second virtual network interface card device. Further, in a case where a first private network IP address of the target service is provided by a first virtual network interface card device, a first virtual network interface card device corresponding to the target service can also be deployed in each service VPC through the VPC network management and control node.

Further, as shown in FIG. 5, this node device further includes: other components such as a communication component 56, a display 57, a power supply component 58, and an audio component 59. Only some components are schematically shown in FIG. 5, which does not mean that the node device only includes the components shown in FIG. 5. It should be noted that, the components indicated by the dashed lines in FIG. 5 are optional components, rather than mandatory components, and may be determined specifically depending on a product form of the node device.

Correspondingly, an embodiment of the present application further provides a computer-readable storage medium stored with a computer program, wherein the computer program, when executed by a processor, causes the processor to be capable of implementing steps in the methods shown in FIG. 3a and FIG. 3b.

Correspondingly, an embodiment of the present application further provides a computer program product including a computer program/instruction, wherein the computer program/instruction, when executed by a processor, causes the processor to implement steps in the methods shown in FIG. 3a and FIG. 3b.

The communication component in the above FIG. 5 is configured to facilitate wired or wireless communication between the device where the communication component is located and other devices. The device where the communication component is located can access a wireless network based on a communication standard, such as Wi-Fi, a mobile communication network such as 2G, 3G, 4G/LTE, or 5G, or a combination thereof. In one exemplary embodiment, the communication component receives, via a broadcast channel, a broadcast signal or broadcast related information from an external broadcast management system. In one exemplary embodiment, the communication component further includes a Near Field Communication (NFC) module to promote short-range communication. For example, the NFC module can be implemented based on Radio Frequency Identification (RFID) technology, Infrared Data Association (IrDA) technology, Ultra-Wideband (UWB) technology, Bluetooth (BT) technology, and other technologies.

The display in the above FIG. 5 includes a screen, and the screen can include a liquid crystal display (LCD) and a touch panel (TP). If the screen includes a touch panel, the screen can be implemented as a touch screen to receive an input signal from a user. The touch panel includes one or more touch sensors to sense a touch, a swipe, and a gesture on the touch panel. The touch sensor can not only sense a boundary of the touch or swipe action, but also detect a duration and pressure relevant to the touch or swipe operation.

The power supply component in the above FIG. 5 supplies power to various components of the device where the power supply component is located. The power supply component can include a power supply management system, one or more power supplies, and other components associated with generation, management, and distribution of power for the device where the power supply component is located.

The audio component in the above FIG. 5 can be configured to output and/or input an audio signal. For example, the audio component includes one microphone (MIC) that is configured to receive an external audio signal when the device where the audio component is located is in an operation mode, such as a call mode, a recording mode, and a voice recognition mode. The received audio signal can be further stored in the memory or sent via the communication component. In some embodiments, the audio component further includes one speaker for outputting an audio signal.

Those skilled in the art should understand that the embodiments of the present application can be provided as a method, a system, or a computer program product. Therefore, the present application can employ the form of an entirely hardware embodiment, an entirely software embodiment, or an embodiment combining software and hardware aspects. Moreover, the present application can employ the form of a computer program product implemented on one or more computer-usable storage media (including, but not limited to, a disk memory, a CD-ROM, an optical memory, and the like) that include computer-usable program codes.

The present application is described with reference to the flow charts and/or block diagrams of the methods, devices (systems), and computer program products according to the embodiments of the present application. It should be understood that each flow and/or block in the flow charts and/or block diagrams, as well as combinations of flows and/or blocks in the flow charts and/or block diagrams, can be implemented by computer program instructions. These computer program instructions can be provided to a processor of a general-purpose computer, a specialized computer, an embedded processor, or other programmable data processing device to produce one machine, such that the instructions executed by the processor of the computer or other programmable data processing device produce an apparatus for implementing functions designated in one or more flows in a flow chart and/or one or more blocks in a block diagram.

These computer program instructions can also be stored in a computer-readable memory that can guide a computer or other programmable data processing devices to work in a particular way, such that instructions stored in this computer-readable memory produce an article of manufacture including an instruction apparatus that implements functions designated in one or more flows in a flow chart and/or one or more blocks in a block diagram.

These computer program instructions can also be loaded onto a computer or other programmable data processing devices, such that a series of operating steps are executed on the computer or other programmable devices to generate computer-implemented processing, thereby enabling the instructions executed on the computer or other programmable devices to provide steps for implementing functions designated in one or more flows in a flow chart and/or one or more blocks in a block diagram.

In a typical configuration, the computing device includes one or more processors (CPUs), input/output interface, network interface, and memory.

The memory may include a non-permanent storage such as a random-access memory (RAM), and/or non-volatile memory forms such as a read-only memory (ROM) or a flash RAM, in computer-readable media. The memory is an example of the computer-readable media.

The computer-readable media include both permanent and non-permanent, removable and non-removable media that can implement information storage by any method or technology. The information can be computer-readable instructions, data structures, modules of programs, or other data. Examples of computer storage media include, but are not limited to, a phase-change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storages, a cassette tape, a tape magnetic disk storage or other magnetic storage devices, or any other non-transmission media, which can be used to store information that can be accessed by a computing device. As defined herein, the computer-readable media do not include transitory media, such as modulated data signals and carrier waves.

It is to be further noted that terms like “include”, “comprise” or any other variants thereof are intended to cover non-exclusive inclusion, such that a process, method, commodity or device that includes a series of elements not only includes those elements, but also includes other elements that are not explicitly listed, or further includes elements inherent in the process, method, commodity or device. In the absence of more restrictions, an element limited by a sentence “including one . . . ” does not exclude existence of additional identical elements in the process, method, commodity or device that includes the element.

Described above are merely the embodiments of the present application, which are not intended to restrict the present application. For those skilled in the art, the present application can be modified and changed in various ways. Any modification, equivalent replacement, improvement and the like made within the spirit and principle of the present application shall be included in the scope of the claims of the present application.

What is claimed is:

1. A multi-cluster service system, comprising:
a plurality of service clusters for
providing services externally and distributed in a plurality of VPCs;
wherein the plurality of VPCs comprise at least one service VPC responsible for providing a target service and at least one client VPC which can access the target service, and the target service having first service information in each service VPC and second service information in each client VPC;
a multi-cluster load balancing node for
generating in advance an information mapping relationship among second service information which the target service has in each client VPC, first service information which the target service has in each service VPC, and information of a service instance in each service VPC which can provide the target service; and
load-balancing, based on the information mapping relationship, an access request for the target service from any client VPC onto a target service instance in the at least one service VPC, to enable the target service instance to provide the target service for a service instance corresponding to the access request.

2. The system according to claim 1, wherein a first virtual network interface card device is deployed in each service VPC as a traffic access point of a target service, the first virtual network interface card device has a first private network IP address, and first service information which the target service has in the service VPC comprises the first private network IP address and a port number of the target service.

3. The system according to claim 2, wherein a second virtual network interface card device bound to the target service is deployed in each client VPC as a traffic routing point of the target service, the second virtual network interface card device has a second private network IP address, and second service information which the target service has in the client VPC comprises the second private network IP address and a port number or mapped port number of the target service.

4. The system according to claim 3, wherein the multi-cluster load balancing node is specifically used for:
receiving an access request sent by any service instance in any client VPC through access to a second virtual network interface card device in the client VPC, wherein the access request comprises identification information of the any client VPC and a second private network IP address;
determining, according to the identification information of the any client VPC and the second private network IP address, in conjunction with the information mapping relationship, the target service instance and a target private network IP address, wherein the target private network IP address is a first private network IP address which the target service has in a service VPC where the target service instance is located; and
sending, according to an IP address of the target service instance and the target private network IP address, the access request to the target service instance, to enable the target service instance to provide the target service for a service instance corresponding to the access request.

5. The system according to claim 1, wherein the multi-cluster load balancing node is located in a system VPC and is further used for:
deploying, in the system VPC, a third virtual network interface card device bound to the target service, wherein the third virtual network interface card has a third private network IP address, and third service information which the target service has in the system VPC comprises the third private network IP address and a port number of the target service; and
establishing, through the third service information which the target service has in the system VPC, an information mapping relationship among the second service information which the target service has in each client VPC, the first service information which the target service has in each service VPC, and the information of the service instance in each service VPC which can provide the target service.

6. The system according to claim 1, further comprising:
a multi-cluster service management and control node for acquiring and delivering the second service information which the target service has in each client VPC, the first service information which the target service has in each service VPC, and the information of the service instance in each service VPC which can provide the target service to the multiple-cluster load balancing node, to be used by the multiple-cluster load balancing node to locally generate the information mapping relationship.

7. The system according to claim 6, further comprising: a cluster management and control node, and a VPC network management and control node;
wherein the multi-cluster service management and control node is further used for: automatically discovering, in a case where the target service is a containerized service, based on a service exposure mechanism, a target service exposed externally by the at least one service VPC, and at least one client VPC which needs to access the target service, configuring the second service information which the target service has in each client VPC, and acquiring, by the cluster management and control node, the first service information which the target service has in each service VPC, and the information of the service instance in each service VPC which can provide the target service; and
deploying, according to the second service information which the target service has in each client VPC, by the VPC network management and control node, in each client VPC, an endpoint corresponding to the target service.

8. The system according to claim 7, wherein the multi-cluster service management and control node is further used for:
receiving, in a case where the target service is a virtual machine-based service, service configuration information submitted by a user, wherein the service configuration information comprises information of at least one service VPC where the target service is located, the first service information which the target service has in each service VPC, the information of the service instance in each service VPC which can provide the target service, and information of each client VPC which needs to access the target service, and the second service information which the target service has in each client VPC; and
deploying, according to the second service information which the target service has in each client VPC, by the VPC network management and control node, in each client VPC, an endpoint corresponding to the target service.

9. A service access method, applicable to a multi-cluster load balancing node in a multi-cluster service system comprising at least one service VPC responsible for providing a target service and at least one client VPC which can access the target service, the method comprising:
generating in advance an information mapping relationship among second service information which the target service has in each client VPC, first service information which the target service has in each service VPC, and information of a service instance in each service VPC which can provide the target service; and
load-balancing, based on the information mapping relationship, an access request for the target service from any client VPC onto a target service instance in the at least one service VPC, to enable the target service instance to provide the target service for a service instance corresponding to the access request.

10. The method according to claim 9, wherein load-balancing, based on the information mapping relationship, the access request for the target service from the any client VPC onto the target service instance in the at least one service VPC, to enable the target service instance to provide the target service for the service instance corresponding to the access request, comprises:
receiving an access request sent by any service instance in any client VPC through access to a second virtual network interface card device in the client VPC, wherein the access request comprises identification information of the any client VPC and a second private network IP address which the second virtual network interface card device has;
determining, according to the identification information of the any client VPC and the second private network IP address, in conjunction with the information mapping relationship, the target service instance and a target private network IP address, wherein the target private network IP address is a first private network IP address which the target service has in a first virtual network interface card device in a service VPC where the target service instance is located; and
sending, according to an IP address of the target service instance and the target private network IP address, the access request to the target service instance, to enable the target service instance to provide the target service for a service instance corresponding to the access request.

11. The method according to claim 10, wherein sending, according to the IP address of the target service instance and the target private network IP address, the access request to the target service instance, to enable the target service instance to provide the target service for the service instance corresponding to the access request, comprises:
converting a source IP address and a destination IP address of the access request into the target private network IP address and the IP address of the target service instance, respectively; and
sending, via the first virtual network interface card device in the service VPC where the target service instance is located, the access request after address conversion to the target service instance, to enable the target service instance to provide the target service for the service instance corresponding to the access request.

12. The method according to claim 10, wherein the at least one service VPC comprises a plurality of service VPCs distributed in different regions, and determining the target service instance according to the identification information of the any client VPC and the second private network IP address, in conjunction with the information mapping relationship, comprises:
acquiring, according to the identification information of the any client VPC and the second private network IP address in conjunction with the information mapping relationship, the plurality of service VPCs and information of a service instance therein which can provide the target service;
determining, according to regions where the plurality of service VPCs are located and/or the number of service instances contained which can provide the target service, load balancing weights corresponding to the plurality of service VPCs; and
determining, according to the load balancing weights corresponding to the plurality of service VPCs, the target service instance from service instances in the plurality of service VPCs which can provide the target service.

13. The method according to claim 12, wherein determining, according to the regions where the plurality of service VPCs are located, the load balancing weights corresponding to the plurality of service VPCs, comprises:
determining, according to a location relationship between regions where the plurality of service VPCs are located and a region where the multi-cluster load balancing node is located, the load balancing weights corresponding to the plurality of service VPCs;
wherein a load balancing weight of a service VPC located in a same region as the multi-cluster load balancing node is greater than a load balancing weight of a service VPC located in a different region from the multi-cluster load balancing node.

14. The method according to claim 9, wherein generating in advance the information mapping relationship among the second service information which the target service has in each client VPC, the first service information which the target service has in each service VPC, and the information of the service instance in each service VPC which can provide the target service, comprises:
deploying, in a system VPC where the multi-cluster load balancing node is located, a third virtual network interface card device bound to the target service, wherein the third virtual network interface card has a third private network IP address, and third service information which the target service has in the system VPC comprises the third private network IP address and a port number of the target service; and
establishing, through the third service information which the target service has in the system VPC, an information mapping relationship among the second service information which the target service has in each client VPC, the first service information which the target service has in each service VPC, and the information of the service instance in each service VPC which can provide the target service.

15. An information configuration method, applicable to a multi-cluster service management and control node in a multi-cluster service system comprising at least one service VPC responsible for providing a target service and at least one client VPC which can access the target service, the method comprising:
acquiring and delivering second service information which the target service has in each client VPC, first service information which the target service has in each service VPC, and information of a service instance in each service VPC which can provide the target service to a multi-cluster load balancing node, to be used by the multi-cluster load balancing node to locally generate an information mapping relationship;
wherein the information mapping relationship is used for load balancing an access request for the target service from any client VPC onto a target service instance in the at least one service VPC.

16. The method according to claim 15, wherein acquiring the second service information which the target service has in each client VPC, the first service information which the target service has in each service VPC, and the information of the service instance in each service VPC which can provide the target service, comprises:
automatically discovering, in a case where the target service is a containerized service, based on a service exposure mechanism, a target service exposed externally by the at least one service VPC, and at least one client VPC which needs to access the target service, configuring the second service information which the target service has in each client VPC, and acquiring, by a cluster management and control node, the first service information which the target service has in each service VPC, and the information of the service instance in each service VPC which can provide the target service; or
receiving, in a case where the target service is a virtual machine-based service, service configuration information submitted by a user, wherein the service configuration information comprises information of at least one service VPC where the target service is located, the first service information which the target service has in each service VPC, the information of the service instance in each service VPC which can provide the target service, and information of each client VPC which needs to access the target service, and the second service information which the target service has in each client VPC.

17. The method according to claim 16, further comprising:
deploying, according to the second service information which the target service has in each client VPC, by a VPC network management and control node, in each client VPC, an endpoint corresponding to the target service.

18. A node device for use in a multi-cluster service system, comprising: a memory for storing a computer program, and a processor coupled to the memory for executing the computer program to cause the processor to implement steps in the method according to claim 9.

19. A non-transitory computer-readable storage medium stored with a computer program, wherein the computer program, when executed by a processor, causes the processor to implement steps in the method according to claim 9.

20. The system according to claim 2, further comprising:
a multi-cluster service management and control node for acquiring and delivering the second service information which the target service has in each client VPC, the first service information which the target service has in each service VPC, and the information of the service instance in each service VPC which can provide the target service to the multiple-cluster load balancing node, to be used by the multiple-cluster load balancing node to locally generate the information mapping relationship.
